(19) United States
(12) Patent Application Publication
(10) Pub. No.: US 2020/0378291 A1
(43) Pub. Date: Dec. 3, 2020

(54) EXHAUST TREATMENT SYSTEM FOR WORK VEHICLES AND RELATED FLOW MIXERS

(71) Applicant: CNH Industrial America LLC, New Holland, PA (US)

(72) Inventors: Hesam Abbassi, Birmingham, MI (US); Luca Levato, Modena (IT); Panos Tamamidis, Northbrook, IL (US); Samrendra K. Singh, Bolingbrook, IL (US)

(73) Assignee: CNH INDUSTRIAL AMERICA LLC

(21) Appl. No.: 16/426,539

(22) Filed: May 30, 2019

(51) Int. Cl. F01N 3/28; F01N 3/20; F01N 13/00

(52) U.S. Cl. CPC F01N 3/2892; B01D 53/9418; F01N 13/008; F01N 3/2066

(57) ABSTRACT

An exhaust treatment system for a work vehicle includes a selective catalytic reduction (SCR) system configured to react a mixture of reductant/exhaust with a catalyst to generate a treated exhaust flow. The system also includes a flow conduit in fluid communication with an outlet of the SCR system for receiving the treated exhaust flow and an exhaust sensor positioned within the flow conduit downstream of the SCR outlet. The exhaust sensor is configured to detect an amount of an emission gas present in the treated exhaust flow. Additionally, the system includes a flow mixer positioned upstream of the exhaust sensor. The flow mixer includes first and second sets of swirler vanes configured to impart a spiraling flow trajectory to the treated exhaust flow flowing between the SCR outlet and the exhaust sensor, with the first set of swirler vanes being spaced radially from the second set of swirler vanes.

### FIELD OF THE INVENTION

The present subject matter relates generally to the treatment of engine exhaust gases, and more particularly, to exhaust treatment systems of work vehicles for reducing the amount of damage occurring to an exhaust sensor, such as a nitrous oxide (NOx) sensor, due to water impingement. In addition, the present subject matter relates to flow mixer configurations for use within an exhaust treatment system for a work vehicle.

### BACKGROUND OF THE INVENTION

Typically, work vehicles, such as tractors and other agricultural vehicles, include an exhaust treatment system for controlling engine emissions. As is generally understood, exhaust treatment systems for work vehicles often include a diesel oxidation catalyst (DOC) system in fluid communication with a selective catalytic reduction (SCR) system. The DOC system is generally configured to oxidize carbon monoxide and unburnt hydrocarbons contained within the engine exhaust and may include a mixing chamber for mixing an exhaust reductant, such as a diesel exhaust fluid (DEF) or any other suitable urea-based fluid, into the engine exhaust. For instance, the exhaust reductant is often pumped from a reductant tank mounted on and/or within the vehicle and injected onto the mixing chamber to mix the reductant with the engine exhaust. The resulting mixture may then be supplied to the SCR system to allow the reductant to be reacted with a catalyst in order to reduce the amount of nitrous oxide (NOx) emissions contained within the engine exhaust. A NOx sensor is typically positioned downstream of the SCR system to monitor the amount of NOx emissions still remaining in the exhaust flow existing the exhaust treatment system. The data from the sensor may, for example, be used to control the combustion temperature of the engine and/or the amount of reductant injected into the mixing chamber to ensure that the amount of NOx emissions remains below a given amount.

In many instances, condensate water will accumulate within one or more of the components of the exhaust treatment system, such as within the SCR system. When this occurs, water droplets can be released with the flow of exhaust gases exiting the SCR system. These water droplets often impinge onto the downstream NOx sensor, leading to sensor damage and/or failure due to the thermal shock caused by the sudden drop in temperature along the external surface of the sensor. To alleviate this problem, sensor deflectors have been developed that are configured to be positioned immediately upstream of a NOx sensor to shield the sensor from water impingement. However, such solutions tend to reduce the accuracy of the sensor readings due to the substantial disruption of the exhaust flow near the sensor caused by the deflector.

Accordingly, improved systems for reducing the amount of water damage occurring to an exhaust sensor positioned downstream of an engine exhaust treatment system would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an exhaust treatment system for a work vehicle. The system includes a selective catalytic reduction (SCR) system configured to react a mixture of exhaust reductant and engine exhaust with a catalyst to generate a treated exhaust flow, with the SCR system including an SCR outlet for expelling the treated exhaust flow therefrom. The system also includes a flow conduit in fluid communication with the SCR outlet for receiving the treated exhaust flow expelled from the SCR system and an exhaust sensor positioned within the flow conduit downstream of the SCR outlet. The exhaust sensor is configured to detect an amount of an emission gas present in the treated exhaust flow. Additionally, the system includes a flow mixer positioned upstream of the exhaust sensor. The flow mixer includes first and second sets of swirler vanes configured to impart a spiraling flow trajectory to the treated exhaust flow flowing between the SCR outlet and the exhaust sensor, with the first set of swirler vanes being spaced radially from the second set of swirler vanes.

In another aspect, the present subject matter is directed to an exhaust treatment system for a work vehicle. The system includes a selective catalytic reduction (SCR) system configured to react a mixture of exhaust reductant and engine exhaust with a catalyst to generate a treated exhaust flow, with the SCR system including an SCR outlet for expelling the treated exhaust flow therefrom. The system also includes a flow conduit in fluid communication with the SCR outlet for receiving the treated exhaust flow expelled from the SCR system, and an exhaust sensor positioned within the flow conduit downstream of the SCR outlet. The exhaust sensor is configured to detect an amount of an emission gas present in the treated exhaust flow. In addition, the system includes a flow mixer positioned upstream of the exhaust sensor. The flow mixer includes first and second sets of swirler vanes configured to impart counter-spiraling flow trajectories to radially inner and outer portions of the treated exhaust flow being directed through the flow mixer.

In a further aspect, the present subject matter is directed to a flow mixer for use within an exhaust treatment system of a work vehicle. The flow mixer includes an outer housing extending between an upstream end of the flow mixer and a downstream end of the flow mixer. In addition, the flow mixer includes an inner flow divider spaced radially inwardly from the outer housing, a first set of swirler vanes extending radially inwardly from the inner flow divider, and a second set of swirler vanes extending radially between the outer housing and the inner flow divider. The first set of swirler vanes is oriented in one of a clockwise helical pattern or a counterclockwise helical pattern and the second set of swirler vanes is oriented in the other of the clockwise helical pattern or the counterclockwise helical pattern such that the first and second sets of swirler vanes are configured to impart counter-spiraling flow trajectories to radially inner and outer portions of an exhaust flow directed through the flow mixer.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter;

FIG. 2 illustrates a schematic view of one embodiment of an exhaust treatment system suitable for use with a work vehicle in accordance with aspects of the present subject matter;

FIG. 3 illustrates a simplified, cross-sectional view of a portion of the exhaust treatment system shown in FIG. 2 within box 3-3, particularly illustrating one embodiment of a flow mixer positioned relative to an outlet of the selective catalytic reduction (SCR) system in accordance with aspects of the present subject matter:

FIG. 4 illustrates a cross-sectional view of a portion of the flow conduit extending downstream of the flow mixer shown in FIG. 3, particularly illustrating an example of a counter-spiraling flow of treated exhaust flowing from the mixer;

FIG. 5 illustrates a perspective view of one embodiment of a mixer configuration suitable for the disclosed flow mixer in accordance with aspects of the present subject matter; and

FIG. 6 illustrates a downstream end view of the flow mixer shown in FIG. 5.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an exhaust treatment system for a work vehicle. In several embodiments, the system includes a flow mixer adapted to reduce the amount of water droplet damage occurring to an exhaust sensor, such as a nitrous oxide (NOx) sensor, positioned downstream of an selective catalytic reduction (SCR) system of the exhaust treatment system. For example, the flow mixer may be positioned adjacent to the outlet of the SCR system at a location upstream of the exhaust sensor such that the mixer imparts a spiraling flow trajectory to the flow of treated exhaust expelled from the SCR system. In one embodiment, the flow mixer is configured to impart counter-spiraling flows trajectories to the treated exhaust flow such that both a radially inner spiraling flow and a radially outer spiraling flow of the treated exhaust is directed downstream of the mixer towards the exhaust sensor. Such counter-spiraling flows may facilitate enhanced mixing of the treated exhaust immediately upstream of the exhaust sensor, thereby allowing the sensor to provide more accurate data related to the concentration or amount of the gaseous emission(s) being monitored (e.g., NOx). In addition, the counter-spiraling flows may help facilitate evaporation of any water droplets contained within the treated exhaust and/or may help contain water droplets within the center of the flow of treated exhaust, thereby reducing the likelihood of such water droplets impinging on or otherwise contacting the exhaust sensor.

In accordance with aspects of the present subject matter, the disclosed mixer is positioned relative to SCR outlet to promote improved mixing and turbulence within the flow conduit extending downstream of the SCR outlet, particularly within the area of the conduit extending between the SCR outlet and the location of the downstream exhaust sensor. Specifically, in one or more embodiments of the present subject matter, the mixer is configured to create a highly turbulent flow within a central or radially inner region of the flow conduit, with such turbulent flow having an increased flow velocity relative to the remainder of the treated exhaust flow being directed through the conduit. This highly turbulent flow facilitates the primary break-up of water droplets contained within the treated exhaust by increasing the Weber number (We) associated with the water droplets and also promotes the secondary break-up or atomization of the water droplets by reducing the characteristic atomization timescale. Such improved droplet break-up and atomization results in smaller droplet sizes within the flow conduit. Moreover, the improved mixing and higher turbulence enhances the evaporation of the remaining droplets. Accordingly, the combined effect results in a significant reduction in the probability of large droplets being present downstream of the mixer (e.g., at or adjacent to the location of the exhaust sensor), and, thus, by extension, a substantial reduction in the likelihood of sensor failure or damage due to water droplets impinging on or otherwise contacting the exhaust sensor.

It should be appreciated that, although the disclosed flow mixer is generally described herein with reference to mixing/spiraling the flow of exhaust gases directed between the SCR system and a downstream exhaust sensor to reduce the likelihood of damage occurring to the sensor due to impingement by water droplets, the flow mixer may also be utilized in one or more other locations within an exhaust treatment system and/or may be configured to serve one or more functions within the system. For instance, in addition to being located between the SCR system and the downstream exhaust sensor (or as an alternative thereto), the flow mixer may be positioned within a mixing conduit extending downstream of a DOC system of the exhaust treatment system. In such an embodiment, the flow mixer may be used to impart counter-spiraling flow trajectories to the reductant/exhaust flow expelled from the DOC system to facilitate proper mixing of the reductant and engine exhaust prior to such flow being directed into the downstream SCR system.

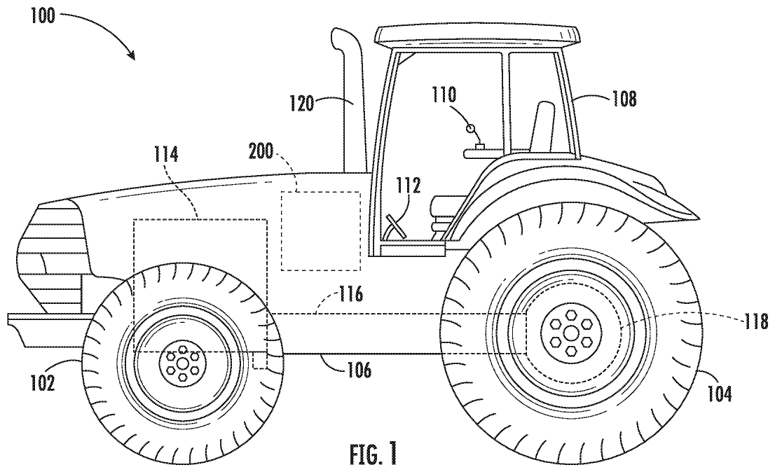

Referring now to the drawings, FIG. 1 illustrates a side view of one embodiment of a work vehicle 100. As shown, the work vehicle 100 is configured as an agricultural tractor. However, in other embodiments, the work vehicle 100 may be configured as any other suitable work vehicle known in the art, such as various other agricultural vehicles, earth-moving vehicles, road vehicles, all-terrain vehicles, off-road vehicles, loaders, and/or the like.

As shown in FIG. 1, the work vehicle 100 includes a pair of front wheels 102, a pair or rear wheels 104, and a chassis 106 coupled to and supported by the wheels 102, 104. An operator's cab 108 may be supported by a portion of the chassis 106 and may house various control devices 110, 112 (e.g., levers, pedals, control panels and/or the like) for permitting an operator to control the operation of the work vehicle 100. Additionally, the work vehicle 100 may include an engine 114 and a transmission 116 mounted on the chassis 106. The transmission 116 may be operably coupled to the engine 114 and may provide variably adjusted gear ratios for transferring engine power to the wheels 104 via a differential 118.

Moreover, the work vehicle 100 may also include an exhaust treatment system 200 for reducing the amount emissions contained within the exhaust from the engine 114. For instance, engine exhaust expelled from the engine 114 may be directed through the exhaust treatment system 200 to allow the levels of nitrous oxide (NOx) emissions contained within the exhaust to be reduced significantly. The cleaned or treated exhaust gases may then be expelled from the exhaust treatment system 200 into the surrounding environment via an exhaust pipe 120 of the work vehicle 100.

It should be appreciated that the configuration of the work vehicle 100 described above and shown in FIG. 1 is provided only to place the present subject matter in an exemplary field of use. Thus, it should be appreciated that the present subject matter may be readily adaptable to any manner of work vehicle configuration 100. For example, in an alternative embodiment, a separate frame or chassis may be provided to which the engine 114, transmission 116, and differential 118 are coupled, a configuration common in smaller tractors. Still other configurations may use an articulated chassis to steer the work vehicle 100, or rely on tracks in lieu of the wheels 102, 104. Additionally, although not shown, the work vehicle 100 may also be configured to be operably coupled to any suitable type of work implement, such as a trailer, spray boom, manure tank, feed grinder, plow and/or the like.

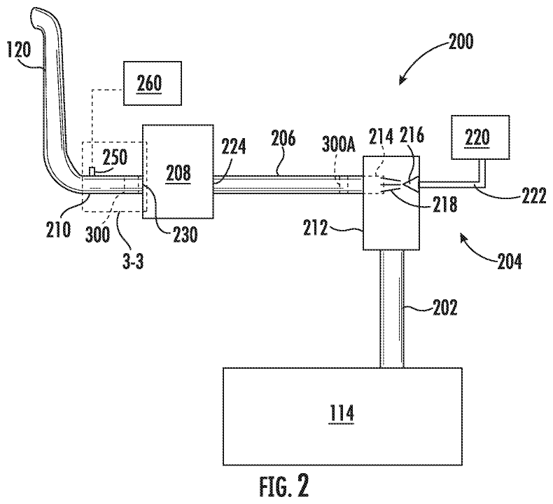

Referring now to FIG. 2, a schematic diagram of one embodiment of an exhaust treatment system 200 suitable for use with a work vehicle 100 is illustrated in accordance with aspects of the present subject matter. As represented in FIG. 2, the exhaust treatment system includes an exhaust conduit 202, a diesel oxidation catalyst (DOC) system 204, a mixing conduit 206, a selective catalytic reduction (SCR) system 208, and a treated exhaust flow conduit 210. During operation of the work vehicle 100, exhaust expelled from the engine 114 is received by the exhaust conduit 202 and flows through the conduit 202 to the DOC system 204. As is generally understood, the DOC system 204 is configured to reduce the levels of carbon monoxide and hydrocarbons present in the engine exhaust. For example, as shown in FIG. 2, the DOC system 204 includes a canister or chamber 212 for receiving engine exhaust from the exhaust conduit 202, with the chamber 212 being in flow communication with an upstream end 214 of the mixing conduit 206. In addition, the DOC system 204 includes a reductant injector nozzle 216 provided in association with the chamber 212 at a location at or adjacent to the upstream end 214 of the mixing conduit 206 to allow an exhaust reductant 218, such as a diesel exhaust fluid (DEF) or any other suitable urea-based fluid, to be injected into the stream of exhaust gases flowing through the chamber 212. For instance, as shown in FIG. 2, the reductant injector nozzle 216 may be fluidly coupled to a source of exhaust reductant (e.g., storage tank 220) via a hose or other fluid coupling 222 to allow liquid exhaust reductant to be supplied to the nozzle 216. The engine exhaust and exhaust reductant flowing into the upstream end 214 of the mixing conduit 206 are then directed through the conduit 206 to the downstream end 224 thereof for receipt by the SCR system 208, within which the mixture of exhaust/reductant is reacted with a catalyst to generate a treated exhaust flow in which the amount of harmful or undesirable gas emissions has been reduced as compared to the engine exhaust initially discharged from the engine 114. The treated exhaust flow is then expelled from an outlet 230 of the SCR system 208 and is directed through the downstream flow conduit 210 for discharge into the atmosphere (e.g., via an exhaust pipe 120 forming part of or coupled to the downstream flow conduit 210).

Additionally, as shown in FIG. 2, the exhaust treatment system 200 includes an exhaust sensor 250 positioned within the downstream flow conduit 210 to monitor the concentration or amount of emissions remaining within the treated exhaust flow following treatment within the SCR system 208. In one embodiment, the exhaust sensor 250 comprises one or more nitrous oxide (NOx) sensors configured to detect the amount of NOx contained within the treated exhaust flow. However, in other embodiments, the exhaust sensor 250 may comprise any other suitable sensor(s) or combination of sensor(s) configured to detect the concentration or amount of gaseous emissions contained within the treated exhaust flow, including the detection of gaseous emissions other than NOx and/or the detection of NOx in combination with one or more other gaseous emissions. As shown, in FIG. 2, in one embodiment, the exhaust sensor 250 is communicatively coupled to a controller 260 (e.g., a computing device or another other suitable processor-based device) configured to monitor the exhaust emissions contained within the treated exhaust flow based on the data received from the sensor 250. The controller 260 may then, for example, compare the concentration or amount of detected exhaust emissions to a predetermined limit or threshold and control one or more components of the work vehicle 100 based on such comparison, such as by adjusting the combustion temperature of the engine 114 and/or varying the amount of reductant injected into the DOC system 204 to ensure that the exhaust emissions remain below the predetermined limit or threshold.

Moreover, the exhaust treatment system 200 may also include a flow mixer 300 positioned at or adjacent to the outlet 230 of the SCR system 208. As will be described in greater detail below, the flow mixer 300 may be configured to impart a rotating or spiraling flow trajectory to the treated exhaust flow expelled from the SCR system 208. For example, in several embodiments, the flow mixer 300 may be configured to generate counter-spiraling flows of the treated exhaust within the downstream flow conduit 210. Such counter-spiraling flows may facilitate enhanced mixing of the treated exhaust immediately upstream of the exhaust sensor 250, thereby allowing the sensor 250 to provide more accurate data related to the concentration or amount of the gaseous emission(s) being monitored (e.g., NOx). In addition, the counter-spiraling flows may help facilitate evaporation of any water droplets contained within the treated exhaust and/or may help contain water droplets within the center of the flow of treated exhaust through the downstream flow conduit 210, thereby reducing the likelihood of such water droplets impinging on or otherwise contacting the exhaust sensor 250.

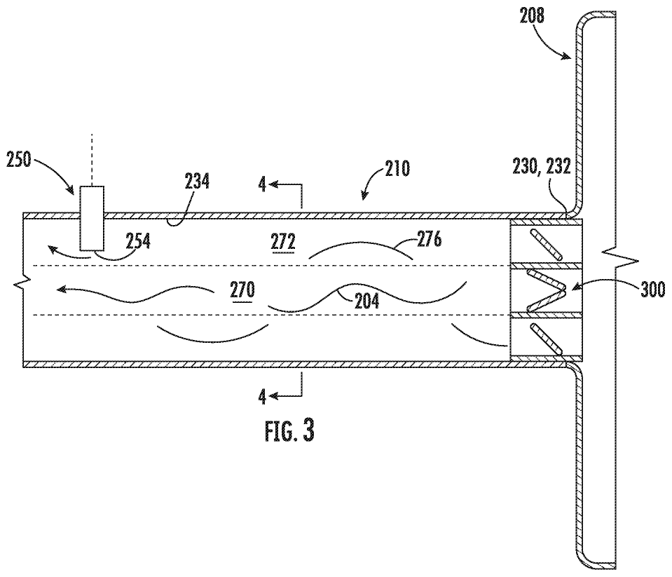

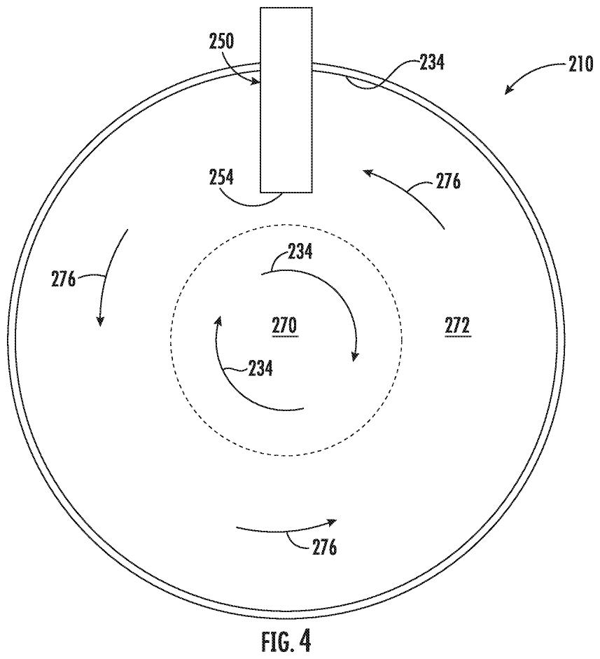

Referring now to FIGS. 3 and 4, cross-sectional views of portions of the exhaust treatment system 200 shown in FIG. 2 are illustrated in accordance with aspects of the present subject matter. Specifically, FIG. 3 illustrates a cross-sectional view of portions of the SCR system 208 and downstream flow conduit 210 contained within box 3-3 shown in FIG. 2, particularly illustrating the flow mixer 300 positioned adjacent the outlet 230 of the SCR system 208 and the exhaust sensor 250 positioned downstream of the flow mixer 300. Additionally, FIG. 4 illustrates a cross-sectional view of the downstream flow conduit 210 shown in FIG. 3 taken about line 4-4, particularly illustrating the counter-spiraling flows of treated exhaust generated by the flow mixer 300.

As indicated above, in several embodiments, the flow mixer 300 is configured to be positioned at or adjacent to the outlet 230 of the SCR system 208. For example, in the illustrated embodiment, the flow mixer 300 is positioned immediately at the interface between the SCR outlet 230 and an adjacent upstream end 232 of the flow conduit 210. However, in other embodiments, the flow mixer 300 may be positioned at any other suitable location relative to the SCR outlet 230, such as at a location upstream of the interface between the SCR outlet 230 and the upstream end 232 of the flow conduit 210 or at a location downstream of the interface and upstream of the exhaust sensor 250.

Additionally, as shown in FIG. 3, the exhaust sensor 250 may be configured to extend radially inwardly from an inner surface 234 of the flow conduit 210 such that at least a portion of the sensor 250 is positioned directly within and/or otherwise directly exposed to the flow of treated exhaust flowing downstream of the mixer 300. In this regard, it should be noted that the exhaust sensor 250 is not shielded or otherwise protected from the flow of treated exhaust via an upstream deflector. Rather, a portion of the treated exhaust flow flows directly into and/or across the exhaust sensor 250 to allow the sensor 250 to provide accurate data relating to the gaseous emission(s) being monitored.

In several embodiments, the flow mixer 300 may be configured to generate counter-spiraling flows of the treated exhaust as the exhaust is directed through the mixer 300 such that the downstream flow profile of the treated exhaust includes a central or radially inner flow region 270 having a flow trajectory that spiral or rotates in a first direction (e.g., clockwise or counterclockwise) and a radially outer flow region 272 having a flow trajectory that spirals or rotates in the opposite direction (e.g., the other of the clockwise or counterclockwise direction). Specifically, in the embodiment shown in FIGS. 3 and 4, the central or radially inner flow region 270 is characterized by a flow trajectory (indicated by arrows 274) that spirals in a clockwise direction (e.g., as depicted in the cross-sectional view of FIG. 4) and the radially outer flow region 272 is characterized by a flow trajectory (indicated by arrows 276) that spirals in the counterclockwise direction (e.g., as depicted in the cross-sectional view of FIG. 4). Such counter-spiraling flows serve to increase the shear mixing of water droplets into the treated exhaust.

In addition, the shear boundary created between the inner and outer flow regions 270, 272 serves to prevent or reduce the likelihood that any water droplets contained within the inner flow region 270 flow into the outer flow region 272 downstream of the mixer 300. As a result, the outer flow region 272 may correspond to a radial space within the flow conduit 202 of reduced water impingement probability. In this regard, as particularly shown in FIGS. 3 and 4, the extent to which the exhaust sensor 250 extends radially inwardly from the inner surface 234 of the flow conduit 210 may be selected, for example, such that a radially inner end 254 of the exhaust sensor 250 is positioned within the outer flow region 272 (i.e., is positioned radially outwardly of the boundary defined between the inner and outer flow regions 270, 272).

Moreover, the highly turbulent flow created within the inner flow region of the flow conduit 202 will typically include an increased flow velocity relative to the remainder of the treated exhaust flow being directed through the conduit 202. This highly turbulent flow facilitates the primary break-up of water droplets contained within the treated exhaust by increasing the Weber number (We) associated with the water droplets and also promotes the secondary break-up or atomization of the water droplets by reducing the characteristic atomization timescale. Such improved droplet break-up and atomization results in smaller droplet sizes within the flow conduit and the higher turbulence enhances the evaporation of the remaining droplets. Accordingly, the likelihood of water droplets impinging against the exhaust sensor 250 may be reduced significantly, thereby reducing the potential for sensor damage due to such water droplet impingements.

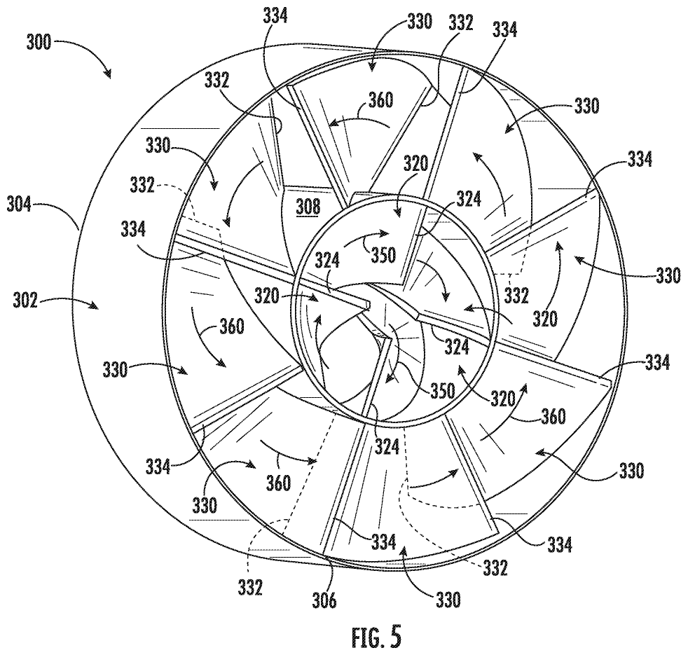

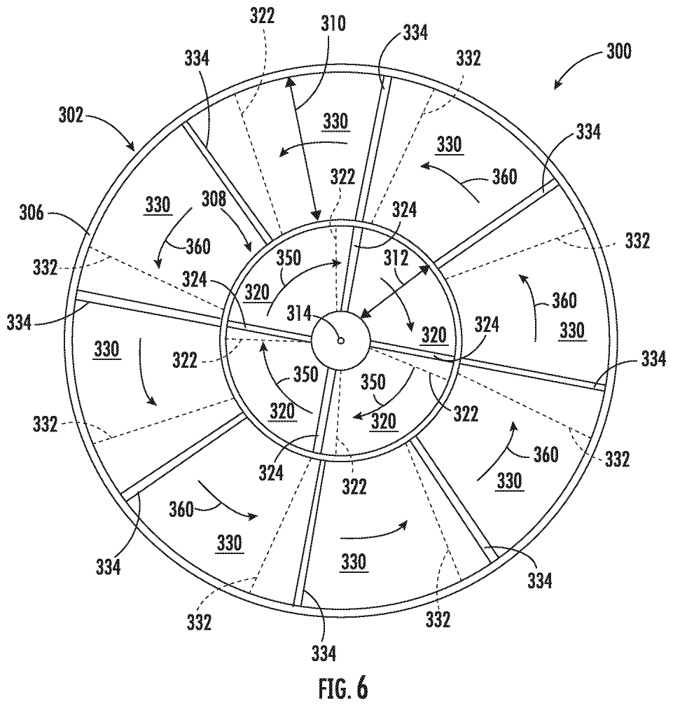

Referring now to FIGS. 5 and 6, differing views of one embodiment of a suitable mixer configuration for the disclosed flow mixer 300 is illustrated in accordance with aspects of the present subject matter. Specifically, FIG. 5 illustrates a perspective view of the flow mixer 300 and FIG. 6 illustrates a downstream end view of the flow mixer 300. It should be appreciated that the mixer configuration shown in FIGS. 5 and 6 is illustrated to provide one exemplary embodiment of a flow mixer that can be used within the disclosed system 200. However, in other embodiments, the flow mixer 300 may have any other suitable configuration consistent the disclosure provided herein.

As particularly shown in FIG. 5, the flow mixer 300 includes an annular, tube-shaped outer housing 302 extending axially between an upstream end 304 and a downstream end 306 of the flow mixer 300. The outer housing 302 generally defines the outer perimeter of the flow mixer 300. Additionally, the flow mixer includes an annular, tube-shaped inner flow divider 308 extending axially between the upstream and downstream ends 304, 306 of the flow mixer 300, with the inner flow divider 308 being spaced radially inwardly from the outer housing 302. In such an embodiment, as shown in FIG. 6, a radially outer flow area 310 of the flow mixer 300 may generally be defined radially between the outer housing 302 and the inner flow divider 308 while a radially inner flow area 312 of the flow mixer 300 may generally be defined radially within the inner flow divider 308 (i.e., radially between the wall of the divider 308 and a central axis 314 (FIG. 6) of the flow mixer 300). In one embodiment, the outer housing 302 and the inner flow divider 308 may be coaxially aligned along the central axis 314 of the flow mixer 300.

Additionally, as shown in the illustrated embodiment, first and sets of circumferentially spaced swirler vanes are positioned within the inner and outer flows areas 312, 310 of the mixer 300, respectively. Specifically, the flow mixer 300 includes a plurality of first swirler vanes 320 extending radially inwardly from the inner flow divider 308 within the inner flow area 312 of the mixer 300. Additionally, the flow mixer 300 includes a plurality of second swirler vanes 330 extending radially between the outer housing 302 and the inner flow divider 308 within the outer flow area 310 of the mixer 300. As shown in the illustrated embodiment, each first swirler vane 320 includes an upstream edge 322 (e.g., as indicated by dashed lines in FIG. 6) positioned closest to the upstream end 304 of the mixer 300 and a downstream edge 324 positioned closest to the downstream end 306 of the mixer 300. Similarly, each second swirler vane 330 includes an upstream edge 332 (e.g., as indicated by dashed lines in FIG. 6) positioned closest to the upstream end 304 of the mixer 300 and a downstream edge 334 positioned closest to the downstream end 306 of the mixer 300.

In several embodiments, each swirler vane 320, 330 may be configured to define a spiral-like profile between its upstream and downstream edges 322, 332, 324, 334. Specifically, each swirler vane 320, 330 may spiral circumferentially as the vane extends axially between its upstream and downstream edges 322, 332, 324, 334. As a result, each set of swirler vanes 320, 330 may define a spiraling or helical pattern within its respective flow area 310, 312 of the mixer 300. This helical pattern may allow the swirler vanes 320, 330 to impart a spiraling flow trajectory to the treated exhaust as it flows through the mixer 300.

In several embodiments, the first set of swirler vanes 320 may define a spiraling or helical pattern that is oriented in an opposite direction than the spiraling or helical pattern defined by the second set of swirler vanes 330. For example, as shown in the illustrated embodiment, the first swirler vanes 320 spiral in a clockwise direction (as viewed in FIGS. 5 and 6) between their upstream and downstream edges 322, 324 while the second swirler vanes 330 spiral in a counterclockwise direction (as viewed in FIGS. 5 and 6) between their upstream and downstream edges 332, 334. As a result, the swirler vanes 320, 330 may be configured to impart counter-spiraling flow trajectories to the treated exhaust flowing through the mixer 300. Specifically, in the illustrated embodiment, a clockwise spiraling flow trajectory (as indicated by arrows 350) may be imparted by the first swirler vanes 320 to the portion of the treated exhaust directed through the inner flow area 312 of the mixer 300 while a counterclockwise spiraling flow trajectory (as indicated by arrows 360) may be imparted by the second swirler vanes 330 to the portion of the treated exhaust directed through the outer flow area 310 of the mixer 300. Such counter-spiraling flows 350, 260 may, in turn, result in the radially inner and outer flow regions 312, 310 of the downstream flow conduit 110 described above with reference to FIGS. 3 and 4.

As particularly shown in FIG. 6, in one embodiment, each set of swirler vanes 320, 330 may be arranged in a circumferentially overlapping manner relative to the axial direction of the flow mixer 300 such that no flow gaps are defined directly axially though the flow splitter 300. For example, as shown in FIG. 6, the downstream edge 324 of each first swirler vane 320 circumferentially overlaps the upstream edge 322 (indicated by the dashed line) of the immediately adjacent first swirler vane 320. Similarly, as shown in FIG. 6, the downstream edge 334 of each second swirler vane 330 circumferentially overlaps the upstream edge 332 (indicated by the dashed line) of the immediately adjacent second swirler vane 330. As a result, all of the treated exhaust directed through the flow mixer 300 may be subjected to the spiraling or helical patterns of the first and second sets of swirler vanes 320, 330, thereby increasing the effectiveness of imparting the spiraling flow trajectories to the treated exhaust.

It should be appreciated that, although the mixer configuration shown in FIGS. 5 and 6 is generally described herein with reference to mixing/spiraling the flow of exhaust gases directed between the SCR system 208 and the downstream exhaust sensor 250, the flow mixer 300 may also be utilized in one or more additional locations within the exhaust treatment system 200. For instance, in addition to being located between the SCR system 208 and the downstream exhaust sensor 250 (or as an alternative thereto), the flow mixer 300 may be positioned within the mixing conduit 206 (e.g., at a location between the upstream and downstream ends 214, 224 of the mixing conduit 206) extending between the DOC system 204 and the SCR system 208, such as at the location indicated by dashed lines 300A in FIG. 2. In such an embodiment, the flow mixer 300 may be used to impart counter-spiraling flow trajectories to the reductant/exhaust flow expelled from the DOC system 204 to facilitate proper mixing of the reductant and engine exhaust prior to such flow being directed into the SCR system 208.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed:

1. An exhaust treatment system for a work vehicle, the system comprising:
a selective catalytic reduction (SCR) system configured to react a mixture of exhaust reductant and engine exhaust with a catalyst to generate a treated exhaust flow, the SCR system including an SCR outlet for expelling the treated exhaust flow therefrom;
a flow conduit in fluid communication with the SCR outlet for receiving the treated exhaust flow expelled from the SCR system;
an exhaust sensor positioned within the flow conduit downstream of the SCR outlet, the exhaust sensor being configured to detect an amount of an emission gas present in the treated exhaust flow; and
a flow mixer positioned upstream of the exhaust sensor, the flow mixer including first and second sets of swirler vanes configured to impart a spiraling flow trajectory to the treated exhaust flow flowing between the SCR outlet and the exhaust sensor,
wherein the first set of swirler vanes is spaced radially from the second set of swirler vanes.

2. The system of claim 1, wherein the first and second sets of swirler vanes are configured to impart counter-spiraling flow trajectories to radially inner and outer portions, respectively, of the treated exhaust flow being directed through the flow mixer.

3. The system of claim 2, wherein the counter-spiraling flow trajectories imparted by the flow mixer result in both a radially inner flow region within the flow conduit downstream of the flow mixer in which the radially inner portion of the treated exhaust flow spirals in a first direction and a radially outer flow region within the flow conduit downstream of the flow mixer in which the radially outer portion of the treated exhaust flow spirals in a second direction opposite the first direction.

4. The system of claim 3, wherein the exhaust sensor extends radially inwardly within the flow conduit such that a radially inner end of the exhaust sensor is positioned within the radially outer flow region of the flow conduit.

5. The system of claim 2, wherein the first set of swirler vanes is oriented in one of a clockwise helical pattern or a counterclockwise helical pattern and the second set of swirler vanes is oriented in the other of the clockwise helical pattern or the counterclockwise helical pattern.

6. The system of claim 1, wherein the flow mixer is positioned adjacent to the SCT outlet.

7. The system of claim 1, wherein the flow mixer defines an upstream end and a downstream end, the first and second sets of swirler vanes being disposed within the flow mixer between the upstream and downstream ends.

8. The system of claim 7, wherein each swirler vane of the first set of swirler vanes is provided in a circumferentially overlapping arrangement with adjacent swirler vanes of the first set of swirler vanes in an axial direction of the flow mixer and each swirler vane of the second set of swirler vanes is provided in a circumferentially overlapping arrangement with adjacent swirler vanes of the second set of swirler vanes in the axial direction of the flow mixer.

9. The system of claim 1, wherein the flow mixer includes an outer housing and an inner flow divider spaced radially inwardly from the outer housing.

10. The system of claim 9, wherein the first set of swirler vanes extends radially inwardly from the inner flow divider and the second set of swirler vanes extends radially between the outer housing and the inner flow divider.

11. The system of claim 10, wherein the first set of swirler vanes is oriented in one of a clockwise helical pattern or a counterclockwise helical pattern and the second set of swirler vanes is oriented in the other of the clockwise helical pattern or the counterclockwise helical pattern.

12. The system of claim 1, wherein the exhaust sensor is positioned directly within a flow path of the treated exhaust flow directed through the flow conduit.

13. The system of claim 1, wherein the exhaust sensor is a nitrous oxide (NOx) sensor.

14. An exhaust treatment system for a work vehicle, the system comprising:
a selective catalytic reduction (SCR) system configured to react a mixture of exhaust reductant and engine exhaust with a catalyst to generate a treated exhaust flow, the SCR system including an SCR outlet for expelling the treated exhaust flow therefrom;
a flow conduit in fluid communication with the SCR outlet for receiving the treated exhaust flow expelled from the SCR system;
an exhaust sensor positioned within the flow conduit downstream of the SCR outlet, the exhaust sensor being configured to detect an amount of an emission gas present in the treated exhaust flow; and
a flow mixer positioned upstream of the exhaust sensor, the flow mixer including first and second sets of swirler vanes configured to impart counter-spiraling flow trajectories to radially inner and outer portions of the treated exhaust flow being directed through the flow mixer.

15. The system of claim 14, wherein the counter-spiraling flow trajectories imparted by the flow mixer result in both a radially inner flow region within the flow conduit downstream of the flow mixer in which the radially inner portion of the treated exhaust flow spirals in a first direction and a radially outer flow region within the flow conduit downstream of the flow mixer in which the radially outer portion of the treated exhaust flow spirals in a second direction opposite the first direction.

16. The system of claim 15, wherein the exhaust sensor extends radially inwardly within the flow conduit such that a radially inner end of the exhaust sensor is positioned within the radially outer flow region of the flow conduit.

17. The system of claim 14, wherein the flow mixer includes an outer housing and an inner flow divider spaced radially inwardly from the outer housing, the first set of swirler vanes extending radially inwardly from the inner flow divider and the second set of swirler vanes extending radially between the outer housing and the inner flow divider.

18. The system of claim 17, wherein the first set of swirler vanes is oriented in one of a clockwise helical pattern or a counterclockwise helical pattern and the second set of swirler vanes is oriented in the other of the clockwise helical pattern or the counterclockwise helical pattern.

19. A flow mixer for use within an exhaust treatment system of a work vehicle, the flow mixer comprising:
an outer housing extending between an upstream end of the flow mixer and a downstream end of the flow mixer;
an inner flow divider spaced radially inwardly from the outer housing;
a first set of swirler vanes extending radially inwardly from the inner flow divider; and
a second set of swirler vanes extending radially between the outer housing and the inner flow divider,
wherein the first set of swirler vanes is oriented in one of a clockwise helical pattern or a counterclockwise helical pattern and the second set of swirler vanes is oriented in the other of the clockwise helical pattern or the counterclockwise helical pattern such that the first and second sets of swirler vanes are configured to impart counter-spiraling flow trajectories to radially inner and outer portions of an exhaust flow directed through the flow mixer.

20. The flow splitter of claim 19, wherein each swirler vane of the first set of swirler vanes is provided in a circumferentially overlapping arrangement with adjacent swirler vanes of the first set of swirler vanes in an axial direction of the flow mixer and each swirler vane of the second set of swirler vanes is provided in a circumferentially overlapping arrangement with adjacent swirler vanes of the second set of swirler vanes in the axial direction of the flow mixer.
